(19) United States
(12) Patent Application Publication
(10) Pub. No.: US 2009/0226055 A1
(43) Pub. Date: Sep. 10, 2009

(54) SYSTEMS AND METHODS FOR MULTI-DIMENSIONAL CHARACTERIZATION AND CLASSIFICATION OF SPINAL SHAPE

(76) Inventors: Harry Dankowicz, Champaign, IL (US); Justin Hutchison, Laurel, MD (US); Jeffrey Shilt, Winston-Salem, NC (US)

Correspondence Address: LATIMER, MAYBERRY & MATTHEWS IP LAW, LLP, 13873 PARK CENTER ROAD, SUITE 106, HERNDON, VA, 20171, US

(21) Appl. No.: 11/720,898

(22) PCT Filed: Dec. 12, 2005
(86) PCT No.: PCT/US05/44832

§ 371 Date: Jun. 5, 2007

Related U.S. Application Data
(60) Provisional application No. 60/634,536, filed on Dec. 10, 2004.

(51) Int. Cl. G06K 9/00; G06K 9/36

(52) U.S. Cl. 382/128; 382/285

(57) ABSTRACT

Systems and methods are disclosed for three-dimensional (3-D) characterization and clinical classification of spinal deformity. By choosing three points on frontal and sagittal 2-D images, a 3-D segmented reconstruction of a spine is made available. Two additional bendAg images provide further information for a Lenke classification of the spine under consideration.

This application claims priority to U.S. Provisional Patent Application Ser. No. 60/634,536, filed Dec. 10, 2004, the content of which is hereby incorporated by reference in its entirety into this disclosure.

### BACKGROUND OF THE INVENTION

1. Field of the Invention

The present invention relates to systems and methods for multi-dimensional characterization and classification of spinal shape. More particularly, the present invention relates to systems and methods for three-dimensional virtual reconstruction, clinical classification, and three-dimensional geometric characterization of scoliotic spines from two-dimensional radiographs.

2. Background of the Invention

Scoliosis affects about 2% of the population and is most commonly seen in children 10 years or older. The current clinical paradigm for diagnosing the degree of deformity, assessing the need for external bracing or surgical correction, and designing the surgical corrective instrumentation is poorly resolved and highly personnel-intensive. In a number of cases, corrective surgery is, moreover, unable to satisfactorily address the primary deformity or prevent the occurrence of postoperative, secondary deformities away from the region of fixation [Cook S, Asher M, Lai S M, Shobe J (2000), “Reoperation after primary posterior instrumentation and fusion for idiopathic scoliosis. Toward defining late operative site pain of unknown cause,” Spine 25(4), pp. 463-468].

In clinical practice, a diagnosis of deformity is largely done through coarse-grained, single-plane angular measurements from visual inspection of two-dimensional radiographs without the ability to assess the full three-dimensional nature of the deformity, involving local curvature, local torsion, and vertebral rotation. Although more sophisticated tools, such as CT and MRI scans, may be used to try to provide three-dimensional information, such tools are not routinely employed due to their high cost, limited availability and association with increased exposure to radiation.

Although some attempt has been made to use imaging and computers to study the curve of the spine, the outcome has fallen short of desired results because of lack of proper imaging, proper modeling or the like.

Thus, a need exists in the art for an alternative to the conventional methods of diagnosing and modeling deformity by using a more accurate and efficient way of mapping out the curve of the spine using simple tools.

### SUMMARY OF THE INVENTION

The present invention provides an alternative and enhancement to conventional treatments for diagnosing, characterizing and classifying various forms of spinal shapes, particularly deformities. The invention provides, among other things, a technique to accurately and automatically reproduce a three-dimensional shape of the vertebral column, to classify the spinal geometry according to the Lenke classification scheme; to provide statistical information regarding the sensitivity of the Lenke classification to variations in input and thereby offer a quantitative measure of the certainty of the classification and of alternative classifications; to quantify the three-dimensional geometry of the spinal axis; and to enable simulated studies of alternative classification schemes applied to large populations of virtual or actual patients.

Thus, systems and methods according to the present invention can serve as medical tools to assist the health care professional in quickly, efficiently and accurately assessing the deformity in a patients spine and further classifying such deformity within a known classification scheme with a certain level of statistical confidence.

In one exemplary embodiment of the present invention, a system is disclosed for producing a three-dimensional segmentation of the vertebral column and a two-dimensional segmentation of two separate frontal images obtained when a patient is bending to either side that are used in obtaining the Lenke Classification. A frontal and a lateral image are used for the three-dimensional reconstruction. These are images showing the patient standing up straight. The third (and fourth) images are frontal images showing the patient bending sideways. These latter images contribute to the Lenke classification, but not the three-dimensional reconstruction.

In one exemplary embodiment of the present invention, a system is disclosed for producing a three-dimensional image of a bone structure from two two-dimensional depictions. The system includes one frontal depiction of a bone structure; one side depiction of the bone structure; three control points placed at predetermined locations on the bone structure in each image; two guidance points positioned about each control point; and wherein a three dimensional image of the bone structure is created from the combination of control points and guidance points on each depiction.

In another exemplary embodiment of the present invention, a method is disclosed for producing a Lenke classification of a spine. The system includes one frontal depiction of a spine; one side depiction of the spine; two bending depictions of the spine; three control points placed at predetermined locations on the spine in each image; two guidance points positioned about each control point; and wherein a Lenke classification of the spine is created from the combination of control points and guidance points on each depiction.

In yet another exemplary embodiment of the present invention, a method is disclosed for producing a three-dimensional image of a bone structure from two two-dimensional depictions. The method includes obtaining a frontal depiction of a bone structure; obtaining a side depiction of the bone structure; choosing three control points placed at predetermined locations on the bone structure in each depiction; choosing two guidance points positioned about each control point; and wherein a three dimensional image of the bone structure is created from the combination of control points and guidance points on each depiction.

### BRIEF DESCRIPTION OF THE DRAWINGS

FIG. 1 shows an exemplary embodiment of the present invention as a system for imaging a spine wherein the large dots correspond to control points and the smaller dots correspond to guidance points and the light line corresponds to the interpolating Bezier curve.

FIG. 2 shows a three-dimensional reconstruction of normal-stance vertebral column according to exemplary embodiments of the present invention.

FIG. 3 shows a three-dimensional reconstruction process using control points (large dots) and guidance points (small dots) as well as statistical variability tolerances (circles around dots), according to an exemplary embodiment of the present invention.

FIGS. 4A and 4B show front and side views, respectively, of a reconstructed spine according to an exemplary embodiment of the present invention.

FIGS. 5A and 5B show front and side views, respectively, of an exemplary reconstructed and segmented spine re-imposed on x-ray film, according to an exemplary embodiment of the present invention.

### DETAILED DESCRIPTION OF THE INVENTION

The present invention provides systems and methods for addressing some of the conventional problems associated with diagnosing, mapping and classifying spinal deformities. Significant treatment benefits will be realized with, according to exemplary embodiments of the present invention, a computer-aided system for three-dimensional characterization and classification of spinal deformity as per existing clinical practice. Exemplary systems and methods according to the present invention enable, for example, three-dimensional reconstruction of the spinal geometry from two-dimensional radiographs; automated classification of the spinal geometry according to the Lenke scheme; and statistical assessment of the sensitivity of the classification to inter-observer reliability and intra-observer reproducibility. As a tool for preoperative evaluation of treatment outcome, for example, integrated with a database of shared pre- and postoperative spinal geometries, exemplary embodiments of the present invention reduce the incidence of adverse outcomes, resulting in improved treatment and resulting quality of life for affected individuals.

Throughout this specification, systems and methods are presented for computer-aided three-dimensional (3D) characterization and clinical classification of spinal deformity. Specifically, the exemplary systems and methods provide a health-care professional with, among other things, a computer-aided graphical user interface for: generating a virtual 3D reconstruction of a patient's vertebral column from 2D radiographs; categorizing a patient's spinal geometry according to the Lenke classification scheme based on 2D radiographs; statistically evaluating the robustness of the resultant Lenke classification under random perturbations to user inputs; quantifying the 3D curve characteristics of the reconstructed vertebral column in terms of local curvature and torsion and initial orientation relative to the pelvis at the base of the vertebral column; creating and manipulating 3D curve shapes corresponding to vertebral columns of virtual patients and applying the above functionalities to these virtual spines; and creating large populations of virtual patients for statistical evaluation of the correlation between the Lenke classification and other measures of the 3D shape of the vertebral column. These functionalities may be in a graphical-user interface that allows the user to view the 3D vertebral columns (whether reconstructed or virtual) over a continuum of angles, viewpoints, distances, and apertures. The user interface further allows for the input of curve-defining characteristics either through graphical manipulation or through data entry.

An exemplary system according to the present invention will be described herein. Although the exemplary system is described according to certain features, the present invention is not limited to such features or their combination, and other similar features or other combinations are within the purview and scope of the present invention.

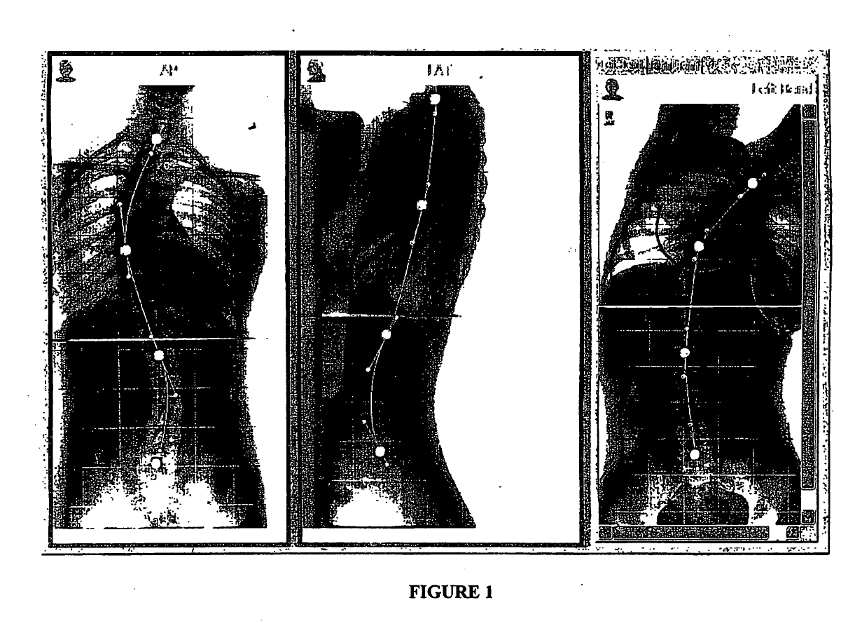

To prepare a three-dimensional reconstruction of a spinal image, an exemplary embodiment begins by considering user selection of a small set of control points and guidance points on digitized two-dimensional radiograph of the patient's spine during normal stance seen in the frontal and sagittal planes, as well as during side-ways bending seen in the frontal plane. See, for example, FIG. 1, which shows control points as large dots and guidance points as smaller dots.

Specifically, with the aid of a pointing device, a user may select, in order, the vertebral body centers of L5, L1, T1, and (optionally) additional intermediate vertebra in the three frontal views. Such selected points are labeled as control points. In each of these views, the user subsequently adjusts additional guidance points about each control point. The guidance points control the shape of a Bezier curve that interpolates the control points and provides a visual fit with the central axis of the spine.

The user then selects, in order, the vertebral body centers of L5 and L1 in the sagittal-plane view. The system considers the vertical spacing between the L5 and L1 vertebral body centers in the frontal-plane view during normal stance to compute a vertical scaling relationship between the two normal-stance radiographs. This is subsequently used by the system to locate, in the vertical direction in the sagittal plane view, the T1 vertebral body center. The user can then shift the location of the corresponding control point in the horizontal direction until it visually coincides with a location on the spine. Additional control points as well as guidance points are subsequently selected and adjusted as discussed above to generate an interpolating Bezier curve that visually fits the central axis of the spine.

As it is conventionally quite difficult to make out the actual location of the T1 vertebral body center in the sagittal plane image, this system addresses the problem in a way whereby the vertical position of the T1 vertebral body center is obtained from the scaling relationship between the two normal-stance views and the positions of the L5 and L1 vertebral body centers and the horizontal position is selected to agree with the apparent central axis of the spine.

It should be noted that the T1 is not the only vertebra that is difficult to make out in the sagittal plane view, but all of the thoracic vertebrae are difficult to make out. Thus, using the principle of nominal spacing as described in this disclosure, such vertebra are segmented from the determination of T1, L5 and L1 placement and estimation of their relative size and distances from each other from empirical data.

To complete the three-dimensional reconstruction, a heuristic segmentation algorithm positions the individual vertebra between L5 and T1 in space along the normal-stance central axis of the spine as obtained from the normal-stance radiographs. Specifically, a nominal spacing as obtained from an undeformed spine is used to position the remaining vertebral body centers between L5 and T1.

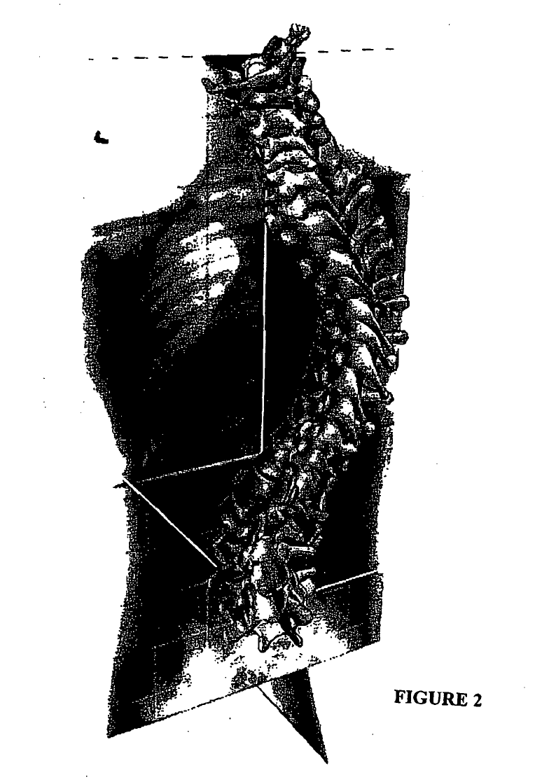

The resultant three-dimensional reconstruction of the vertebral column corresponding to the normal-stance radiographs is subsequently used to arrive at a projected spacing of the vertebral body centers along the central axis of the spine between L5 and T1 in the normal-stance frontal-plane view. An example of a resultant image is shown in FIG. 2. This projected spacing is subsequently used to segment the sideways-bending frontal-plane views.

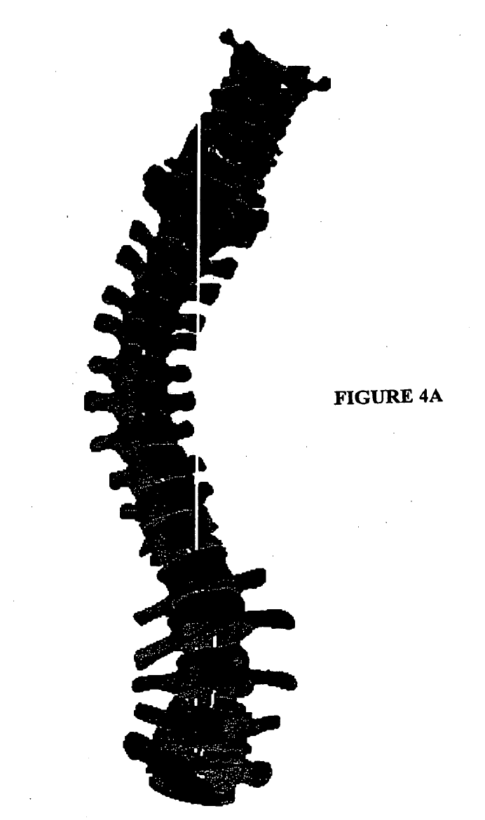

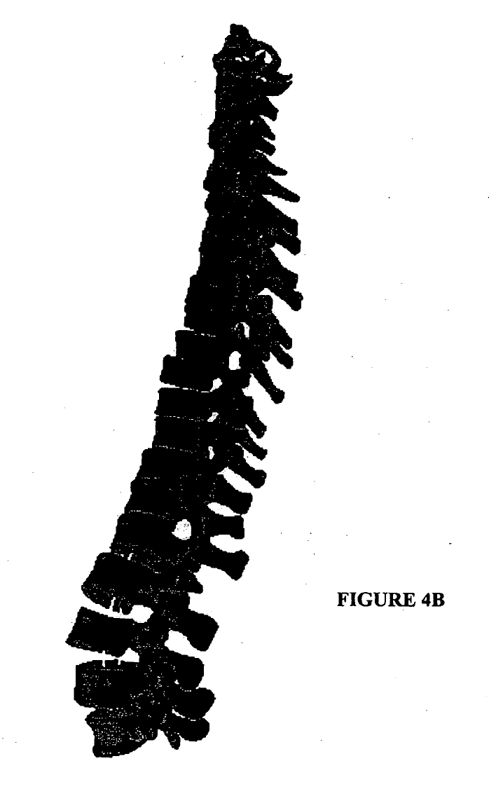

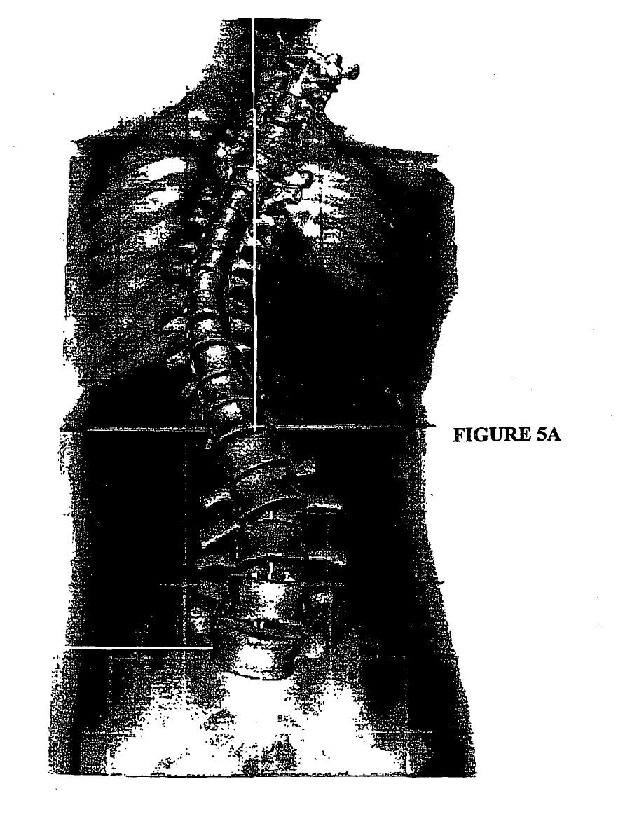

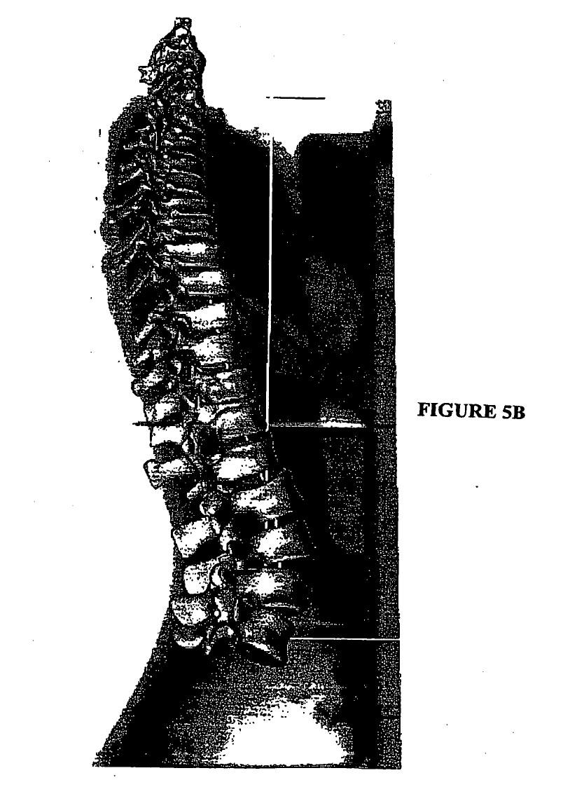

The exemplary system further includes the option for overlaying the three-dimensional reconstruction of the normal-stance vertebral column on top of the normal-stance frontal-plane and sagittal-plane radiographs for visual evaluation of the accuracy of the segmentation. Examples of such isolated segmented images and consequent overlay on radiographs are shown in FIGS. 4A/4B and 5A/5B respectively. Such images are tremendously helpful for a health care practitioner in evaluating the individual vertebra and its interaction and contribution to the overall spine shape from various views. As shown in FIGS. 4 and 5, a frontal view and distances between vertebra from such a view ignores the true spacing between the vertebra since the plane coming out of and into the flat surface of the 2-D image is not considered. With the present invention, such considerations are taken in 3-D such that the true spacing between the vertebra is always considered, even when the vertebra projects into and out of the 2-D image.

The exemplary system described herein further includes the use of a scaling relationship to position T1 in the sagittal-plane view as well as the use of the nominal spacing to segment the normal-stance as well as the sideways-bending radiographs.

An alternative embodiment of the system and method for reconstruction and segmentation could rely on a different subset (other than L5, L1, and T1) for the initial control points and for the scaling between the normal-stance radiographs. Similarly, additional information regarding intermediate vertebra could be employed by the system to recalibrate the intervertebral spacing in different regions of the spine. The intervertebral spacing could also be modified to adjust for gender and age, or to account for clinically observed differences in intervertebral spacing resulting from regions of significant deformity. Alternative embodiments would also include using other interpolating curves, such as splines.

Although the exemplary embodiment described above did not consider the cervical spine, an alternative embodiment of the reconstruction algorithm of the system would extend to the cervical spine by including an additional control point in the cervical region and appropriate guidance points for controlling the interpolating curve. The segmentation algorithm of the system would similarly extend to the cervical region by the use of appropriate intervertebral spacings as discussed above.

Another alternative embodiment of the reconstructive ability of the system also includes user input to define a non-horizontal pelvis orientation. Moreover, an alternative embodiment of the reconstruction algorithm relies on external landmarks placed on the patient during radiography for computing the relative scaling between the normal-stance views.

While the described embodiment does not address the vertebral rotation of each vertebra relative to the local trihedron axis system for sake of simplicity, an alternative embodiment includes user selection of additional control points reflecting the position of vertebral landmarks, for example, processes, on a select subset of vertebra. The algorithm would subsequently use interpolation for the vertebral rotation of intermediate vertebra relative to the local trihedron axis system. Alternatively, the determination of the orientation of the vertebral body relative to the local trihedron axis system is accomplished through a mathematical relationship between the local torsion, e.g., the rate of rotation of the local trihedron axis system about the tangent vector, and the vertebral rotation.

For the classification aspect of the system, the present embodiment implements the Lenke classification algorithm as described in [Lenke L G, Betz R R, Harms J, Bridwell K H, Clements D H, Lowe T G, Blanke K (2001), “Adolescent idiopathic scoliosis: a new classification to determine the extent of spinal arthrodesis,” J Bone Joint Surg Am 83-A(8), pp. 1169-1181] to classify the spinal deformity using the reconstruction afforded above.

Specifically, the segmentation of the frontal-plane and sagittal-plane views along the central axis of the spine (as given by the Bezier curve in each of the views) affords the location of each vertebral body center between L5 and T1 and the tangent direction to the central axis at each of these locations. The tangent direction can be defined, for example, directly from the Bezier curve, from alternative smooth interpolants, for example splines, or from piecewise linear interpolants, in which case the tangent direction is arbitrarily chosen to agree with the direction of one of the linear segments connected to a particular vertebral body center. This information is subsequently used to automatically calculate average changes (so-called “Cobb angles”) in the projected tangent directions between selected vertebra in each of the views as per the Lenke scheme. The system establishes the presence of curve segments in the normal-stance frontal-plane view between points of inflection on the central axis and associates these with a portion of the torso as per the Lenke scheme. Conditional statements involving the coincidence of large Cobb angles in different projections are used to determine the “structural” or “nonstructural” quality of each curve segment. Finally, the lumbar balance of the vertebral column is estimated from the deviation of the lumbar vertebral body centers from the axis through L5 and T1.

Alternative embodiments of the classification algorithm include additional measures of Cobb angles, information from the cervical spine, measures of overall spinal balance (for example, position of center of gravity relative to the line through L5 and T1 as discussed below), as well as average changes in the orientation of the local bending plane (measures of spinal torsion) between selected vertebra. The three-dimensional properties of the central axis of the spine are completely determined by the three-dimensional reconstruction. It follows that computations of the additional measures discussed at the beginning of this paragraph are straightforward and involve established mathematical operations on the rotation matrix describing the orientation of the local trihedron axis system along the spinal axis and the position vector describing the spatial location of the spinal axis.

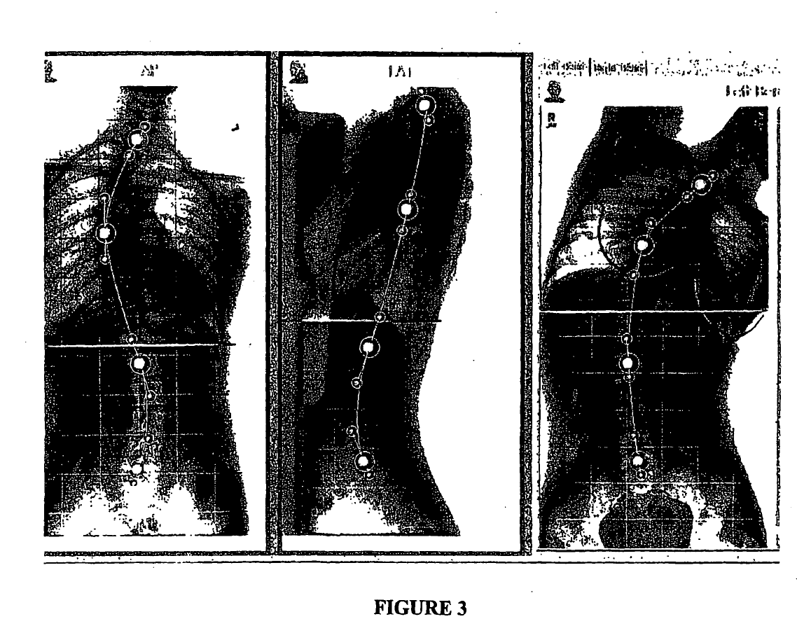

One of the many unique features of exemplary embodiments according to the present invention is an algorithm for introducing random perturbations to the location of the control and guidance points introduced by the user in the three-dimensional reconstruction of the spine and for subsequently classifying the resultant segmented projections of the spine according to the Lenke classification scheme. This ability is based on the ability of picking discrete points (control and guidance points) to generate the spinal curve. As shown in FIG. 3, a user may not only pick the control and guidance points, but also may control the variability of the location of the center of such control and guidance points by varying the circle of variability about the point. Such ability allows for inter-user and intra-user variability in measuring the same or similar spine radiographs.

Specifically, through a set of user-defined optional parameters that characterize the random perturbation, a large number (also user-defined) of perturbed reconstructed spines and associated Lenke classifications may be obtained that differ as a result of small variations in the location of the control and guidance points as originally introduced by the user. The thus obtained Lenke classifications are then statistically analyzed to provide descriptive information about the incidence of a particular classification.

Several studies of the Lenke (and earlier) classification schemes [Cummings R J, Loveless E A, Campbell J, Samelson S, Mazur J M (1998), “Interobserver reliability and intraobserver reproducibility of the system of King et al. for the classification of adolescent idiopathic scoliosis,” J Bone Joint Surg Am, 80(8), pp. 1107-1111; King HA (1988), “Selection of fusion levels for posterior instrumentation and fusion in idiopathic scoliosis,” Orthop Clin North Am, 19(2), pp. 247-255; Lenke L G, Betz R R, Bridwell K H, Clements D H, Harms J, Lowe T G, Shufflebarger H L (1998), “Intraobserver and interobserver reliability of the classification of thoracic adolescent idiopathic scoliosis,” J Bone Joint Surg Am, 80(8), pp. 1097-1106; Lenke L G, Betz R R, Haher T R, Lapp M A, Merola A A, Harms J, Shufflebarger H L (2001b), “Multisurgeon assessment of surgical decision-making in adolescent idiopathic scoliosis: curve classification, operative approach, and fusion levels,” Spine, 26(21), pp. 2347-2353; Lenke L G, Betz R R, Clements D, Merola A, Haher T, Lowe T, Newton P, Bridwell K H, Blanke K (2002), “Curve prevalence of a new classification of operative adolescent idiopathic scoliosis: does classification correlate with treatment?” Spine, 27(6), pp. 604-611; Ogon M, Giesinger K, Behensky H, Wimmer C, Nogler M, Bach C M, Krismer M (2002), “Interobserver and intraobserver reliability of Lenke's new scoliosis classification scheme,” Spine, 27(8), pp. 858-862] have concerned themselves with the inter-observer reliability and intra-observer reproducibility of the classification schemes. Here, inter-observer reliability refers to the variability in the resultant classification as performed by different individuals. Similarly, intra-observer reproducibility refers to the variability in the resultant classification as performed by the same individual on different occasions.

The random-perturbations feature and the associated statistical analysis discussed here afford a way of simulating the variability between different individuals as well as between the same individual on different occasions. It can assess the strength of a particular classification by relating this to the relative incidence of this classification in the population of randomly perturbed reconstructed spines. It can also assess the appropriateness of the classification scheme, as a scheme with large variability is unlikely to provide a reliable assessment of the spinal deformity.

Alternative embodiments of the random-perturbations segment of exemplary embodiments of the present invention would apply the same technique to alternative forms of user input as discussed above in the section on the three-dimensional reconstruction aspect of the system. A component of the system is the introduction of artificial variability in the parameters that mathematically characterize the central axis of the spine (however these are obtained) and the subsequent classification as per the Lenke or alternative schemes. Indeed, such random variability could equally well be introduced on a mathematical description of the central axis that would be obtained from one of the automated aspects of the system described above.

The present embodiment includes aspects for quantifying the three-dimensional shape of the reconstructed central axis of the spine in terms of the local curvature and torsion as well as initial orientation of the local trihedron axis system at L5 relative to the pelvis as defined in the mathematical theory of differential geometry of spatial curves.

Specifically, the local curvature is a measure of the rate of change of the tangent direction to the central axis of the spine along the spine and has units of angles per unit distance. Similarly, the local torsion is a measure of the rate of change of the plane of bending of the central axis of the spine along the spine and has units of angles per unit distance. The present exemplary embodiment is able to compute the local curvature and torsion either pointwise along a smooth interpolant, or in terms of average changes in tangent direction and bending plane between subsequent vertebra.

Alternative embodiments for quantifying the three-dimensional geometry involve measures of the deviation of a reconstructed spine from a reference spine. Such deviations can include, for example, pointwise spatial distances between corresponding vertebra on the two spines; mean spatial distances across the entire length of the two spines or portions thereof; root-mean-square distances across the entire length of the two spines or portions thereof; pointwise absolute values of the differences in local curvature or local torsion between corresponding vertebra on the two spines; and mean and root-mean square differences in local curvature or local torsion across the entire length of the two spines or portions thereof.

These measures of the deviation between two spines provide information as to the amount of change that needs to be imposed on a deformed spine during correction (either directly through the introduction of surgical rods attached to the spine, or indirectly in regions away from the surgical rods) in order for the corrected spine to agree with the reference spine (ignoring the effects of soft tissue and spatial interference of vertebral processes).

One of the many advantages of the present embodiment includes the ability to generate curve shapes corresponding to the central axes of the spines of virtual patients through the specification of the local curvature (or average change of tangent direction between vertebra) and local torsion (or average change of bending plane between vertebra) along the central axis of the spine combined with information about the initial orientation of the local trihedron axis system at L5 relative to the pelvis.

In the case of specifying the local curvature and torsion pointwise along a smooth curve, the curve shape is generated by solving the Frenet differential equations for the orientation of the local trihedron axis system along the curve relative to the pelvis and subsequently integrating the differential equation relating the position vector from L5 to an arbitrary point on the curve to the current tangent direction at that point.

In the case of specifying average changes in tangent direction and bending plane between subsequent vertebra, the curve shape is generated by discrete changes in the orientation of the local trihedron axis system corresponding to rotations about the trihedral tangent and binormal vectors by amounts given by the corresponding angles at each vertebra and a piecewise linear interpolant. In this and the previous case, the segmentation along the central axis is given by the nominal spacing discussed previously.

Since there is no natural way of generating side bending views for a virtual patient, a modified version of the Lenke classification scheme is considered that ignores information that would otherwise require the sideways bending views (particularly, information used in determining the ‘structural’ or ‘nonstructural’ quality of a curve segment).

Embodiments of the present invention enable the generation of large populations of virtual spines and subsequent classification of these as per the modified Lenke classification scheme. The resultant data is stored in such a way as to afford a straightforward means to correlate the incidence of a particular classification with three-dimensional characteristics of the virtual spines not explicitly included in the Lenke classification scheme, for example, measures of overall spinal balance, such as the location of the center of gravity of the torso relative to the axis through L5 and T1 or relative to a vertical line through L5 as mentioned previously.

Alternative embodiments of the curve-generating algorithm include the ability to generate large numbers of virtual patients through a random selection of the local curvature, local torsion, and initial orientation values that uniquely specify each curve. These values could, for example, be selected to vary about a mean defined by a preselected reference curve, such as a nominally undeformed curve or a curve obtained from three-dimensional reconstruction of two-dimensional radiographs of an actual patient. To eliminate nonphysical curves, selection criteria can be introduced that only retain a subset of the virtual spines, for example, those whose vertically projected center of gravity of the torso falls within a nominal width of the pelvis, or those that never exceed critical values for the local curvature and/or local torsion, or those that never exceed critical values for the angle between the tangent direction at selected vertebra and the vertical.

Alternative embodiments include additional modifications to the classification scheme, as already discussed. Moreover, the measures of deviation between pairs of spines as mentioned could be used to quantify the degree of similarity between spines within the same classification category as well as the degree of difference between spines in different categories.

As a natural extension of the ability to generate virtual spines as per the discussion above, and unique to the present embodiment, is the ability for manipulating the reconstructed three-dimensional vertebral column of actual patients as obtained from the normal-stance frontal- and sagittal-plane radiographs.

Specifically, a user may modify the local curvature, torsion (or the corresponding average changes in the piecewise linear case), and initial orientations of the reconstructed spine to study the change in overall geometry that would result from the surgical introduction of such changes to the actual spine neglecting the influence of soft tissue and the possible spatial interference of the vertebral bodies.

This feature, coupled with the ability to view the spine from a multitude of viewpoints, distances, and apertures, affords the surgeon a tool for designing subsequent intervention, as well as for communicating the analysis and the proposed intervention to the patient.

An alternative embodiment of the algorithm would allow the user to select a subset of vertebra for which the local curvatures and local torsion could be made to agree (to within a user-defined distance) with the corresponding values for a reference spine, and similarly for the initial orientation. An alternative embodiment includes an interpolating aspect that generates the reconstructed three-dimensional vertebral column as the local curvature (and/or local torsion and/or initial orientation) is changed in user-defined steps between the initial values corresponding to the original spine and the final values corresponding to the reference spine. The sequence of thus generated virtual spines could then be animated to show the transition between the initial and final shape under these imposed changes.

Yet another exemplary embodiment of the present invention includes the combination of preoperative and postoperative three-dimensional reconstructions and associated automatically generated Lenke classifications in a searchable database that would include statistical features for assessing the correlation between pre- and postoperative classifications as well as between the postoperative classification and additional three-dimensional characteristics of the spinal curve not explicitly captured by the Lenke classification.

Although the above examples have been presented with respect to a bending spine, the present technique is not limited to a bending spine but may be used in determining the segmentation of a stretched spine or the geometry or volume of other internal organs. In the case of a stretched spine, the same techniques may be used as described above but with the substitution of traction images for bending images of the spine, wherein some amount of traction is applied to the patient along the head-toe axis. To produce such reconstructed spine using a traction model, stretched images of the spine may be used, in conjunction with the front and side depictions, to determine the geometry, shape and classification of the spine. In the case of other organs, additional features may be added to allow the user to generate three-dimensional representations of the pulmonary cavity (the cavity within which the lungs reside), which could be used to determine the need for surgical intervention. Such three-dimensional representations would include, for example, picking points on locations on the rib cage and fitting a curve to the rib cage's outline in a similar fashion to what is done here. Many other variations are possible and within the scope of the present invention.

Further, the above examples and embodiments may be implemented on a stand-alone software (e.g., may be added to computer or radiographic imaging device), a stand-alone hardware such as an imaging device (e.g., with such ability to segment spine and/or Lenke classification built in), or a combination of software and hardware. When using hardware, proper components such as a computer, a mouse/pointer and imaging equipment would be needed to display the images and pick out the proper points. The proper mode of usage would be apparent to one having ordinary skill in the art after considering the present disclosure and within the scope of the present invention.

The foregoing disclosure of the preferred embodiments of the present invention has been presented for purposes of illustration and description. It is not intended to be exhaustive or to limit the invention to the precise forms disclosed. Many variations and modifications of the embodiments described herein will be apparent to one of ordinary skill in the art in light of the above disclosure. For example, the present invention may also be used for other uses, such as the visual reconstruction of other bone structures. The scope of the invention is to be defined only by the claims appended hereto, and by their equivalents.

Further, in describing representative embodiments of the present invention, the specification may have presented the method and/or process of the present invention as a particular sequence of steps. However, to the extent that the method or process does not rely on the particular order of steps set forth herein, the method or process should not be limited to the particular sequence of steps described. As one of ordinary skill in the art would appreciate, other sequences of steps may be possible. Therefore, the particular order of the steps set forth in the specification should not be construed as limitations on the claims. In addition, the claims directed to the method and/or process of the present invention should not be limited to the performance of their steps in the order written, and one skilled in the art can readily appreciate that the sequences may be varied and still remain within the spirit and scope of the present invention.

What is claimed is:

1. A system for producing a three-dimensional image of a bone structure from two two-dimensional depictions, the system comprising:
one frontal depiction of a bone structure;
one side depiction of the bone structure;
three control points placed at predetermined locations on the bone structure in each image;
two guidance points positioned about each control point; and
wherein a three dimensional image of the bone structure is created from the combination of control points and guidance points on each depiction.

2. The system of claim 1, wherein the bone structure is a spine.

3. The system of claim 2, wherein the control points are placed on various predetermined vertebrae along the spine.

4. The system of claim 3, wherein the predetermined vertebrae include L1, L5 and T1.

5. The system of claim 2, further comprising:
two bending depictions of the spine, wherein in combination with the frontal and side depictions, a Lenke classification is made.

6. The system of claim 5, further comprising:
means to produce a test of statistical robustness of the Lenke classification.

7. The system of claim 2, wherein the three dimensional image of the full spine is made by consideration of intervertebral spacing models.

8. The system of claim 7, wherein the three dimensional image of the spine may be manipulated to different bends to account for the reaction of the spine to such new bends.

9. The system of claim 7, wherein the three dimensional image of the spine may be super-imposed back on any of the frontal or side depictions of the spine.

10. The system of claim 7, wherein the three dimensional intervertebral spacing is combined with the frontal and/or side depictions to segment additional frontal and/or side depictions.

11. The system of claim 2, further comprising:
two stretched depictions of the spine, wherein in combination with the frontal and side depictions, a spinal classification is made.

12. A system for producing a Lenke classification of a spine, the system comprising:
one frontal depiction of a spine;
one side depiction of the spine;
two bending depictions of the spine;
three control points placed at predetermined locations on the spine in each image;
two guidance points positioned about each control point; and
wherein a Lenke classification of the spine is created from the combination of control points and guidance points on each depiction.

13. The system of claim 12, wherein the control points are placed on various predetermined vertebrae along the spine.

14. The system of claim 13, wherein the predetermined vertebrae include L1, L5 and T1.

15. The system of claim 12, further comprising:
means to produce a test of statistical robustness of the Lenke classification.

16. A method for producing a three-dimensional image of a bone structure from two two-dimensional depictions, the method comprising:
obtaining a frontal depiction of a bone structure;
obtaining a side depiction of the bone structure;
choosing three control points placed at predetermined locations on the bone structure in each depiction;
choosing two guidance points positioned about each control point; and
wherein a three dimensional image of the bone structure is created from the combination of control points and guidance points on each depiction.

17. The method of claim 16, wherein the bone structure is a spine.

18. The method of claim 17, wherein the control points are placed on various predetermined vertebrae along the spine.

19. The method of claim 18, wherein the predetermined vertebrae include L1, L5 and T1.

20. The method of claim 16, further comprising:
obtaining two bending depictions of the spine, wherein in combination with the other depictions, a Lenke classification is made.

21. The method of claim 20, further comprising:
determining a statistical robustness of the Lenke classification.

22. The method of claim 16, wherein the three dimensional image of the full spine is made by consideration of intervertebral spacing models.
